(19) United States
(12) Patent Application Publication
(10) Pub. No.: US 2015/0245180 A1
(43) Pub. Date: Aug. 27, 2015

(54) DETERMINING PROXIMITY TO A VENUE

(71) Applicant: Microsoft Technology Licensing, LLC, Redmond, WA (US)

(72) Inventors: Jyh-Han LIN, Mercer Island, WA (US); Chih-Wei WANG, Redmond, WA (US); Stephen P. DiAcetis, Duvall, WA (US)

(73) Assignee: Microsoft Technology Licensing, LLC, Redmond, WA (US)

(21) Appl. No.: 14/192,498

(22) Filed: Feb. 27, 2014

(51) Int. Cl. H04W 4/04

(52) U.S. Cl. CPC H04W 4/04

(57) ABSTRACT

The description relates to mobile device location. One example can access stored survey data relating to a venue. The stored survey data can include internal data from inside the venue and external data from outside the venue. The example can obtain current sensing data at a location proximate to the venue. The example can determine whether the location is inside the venue or outside the venue by comparing the stored survey data and the current sensing data.

### BACKGROUND

Many mobile device users want to know their location relative to a venue. For instance, the user may want directions to get from their current location to a specific location within the venue. Existing techniques tend to give erroneous results when the user's location is in close proximity to the venue. For instance, the techniques may indicate that the user is inside the venue when they are actually just outside.

### SUMMARY

The described implementations relate to mobile device location. One implementation can access stored survey data relating to a venue. The stored survey data can include internal data from inside the venue and external data from outside the venue. The implementation can obtain current sensing data at a location proximate to the venue. The implementation can determine whether the location is inside the venue or outside the venue by comparing the stored survey data and the current sensing data.

The above listed example is intended to provide a quick reference to aid the reader and is not intended to define the scope of the concepts described herein.

### BRIEF DESCRIPTION OF THE DRAWINGS

The accompanying drawings illustrate implementations of the concepts conveyed in the present application. Features of the illustrated implementations can be more readily understood by reference to the following description taken in conjunction with the accompanying drawings. Like reference numbers in the various drawings are used wherever feasible to indicate like elements. Further, the left-most numeral of each reference number conveys the Figure and associated discussion where the reference number is first introduced.

FIGS. 1-2 show an example scenario or environment upon which the present mobile device location concepts can be employed in accordance with some implementations.

FIG. 3 shows an example venue location diagram in accordance with some implementations.

FIG. 4 shows an example venue survey plan in accordance with some implementations.

FIG. 5 shows an example venue location system in accordance with some implementations.

FIGS. 6-7 are flowcharts of examples of mobile device location methods in accordance with some implementations of the present concepts.

### DETAILED DESCRIPTION

### Overview

Many users have come to rely on their mobile devices to tell them where they are and/or to guide them to their desired destination (and/or for other uses). In many cases a desired destination may be a venue or within a venue. “Venue” can mean a building, such as a shopping mall, convention center, office building, or a tunnel system, such as a subway or a sewer system, among others. Considered broadly, the present concepts can be applied to any well-defined area that can be surveyed within and outside. In cases where the user is proximate a venue, multiple positioning technologies may be utilized to identify the location. Even if the location is determined with a high degree of accuracy, it can in some cases be difficult to determine if the user is inside or outside of the venue. For instance, outside in open areas, the mobile device may utilize an absolute positioning technology, such as global positioning system (GPS) (or other global navigation satellite system) to determine the user's location. Alternatively or additionally, various relative positioning technologies may be employed, such as cellular tower triangulation, wireless access point triangulation, etc. Geographic features or manmade structures can render GPS inoperable and increase reliance upon relative positioning technologies.

In many cases, one or more of the positioning technologies can be utilized to determine the user's location within a few feet or tens of feet. In many circumstances, such accuracy is sufficient to provide useful information to the user. For instance, if the mobile device indicates that the user is in the atrium of a shopping mall and the user's real location is actually a few feet away in the atrium, the user experience may be relatively unaffected. However, in some circumstances, such accuracy can lead to anomalies that can be very unsatisfactory to the user. For instance, if the mobile device indicates that the user is inside a venue when they are actually just outside the venue along a wall with no entrance, the user may be very unsatisfied (e.g., the mobile device may indicate that the user is at the desired location when they are physically outside the location or vice versa). The present concepts can address such situations by comparing location information sampled by the mobile device to stored location information relating to the venue. These concepts can utilize this comparison to distinguish instances where the user is just outside the venue from those where the user is inside the venue.

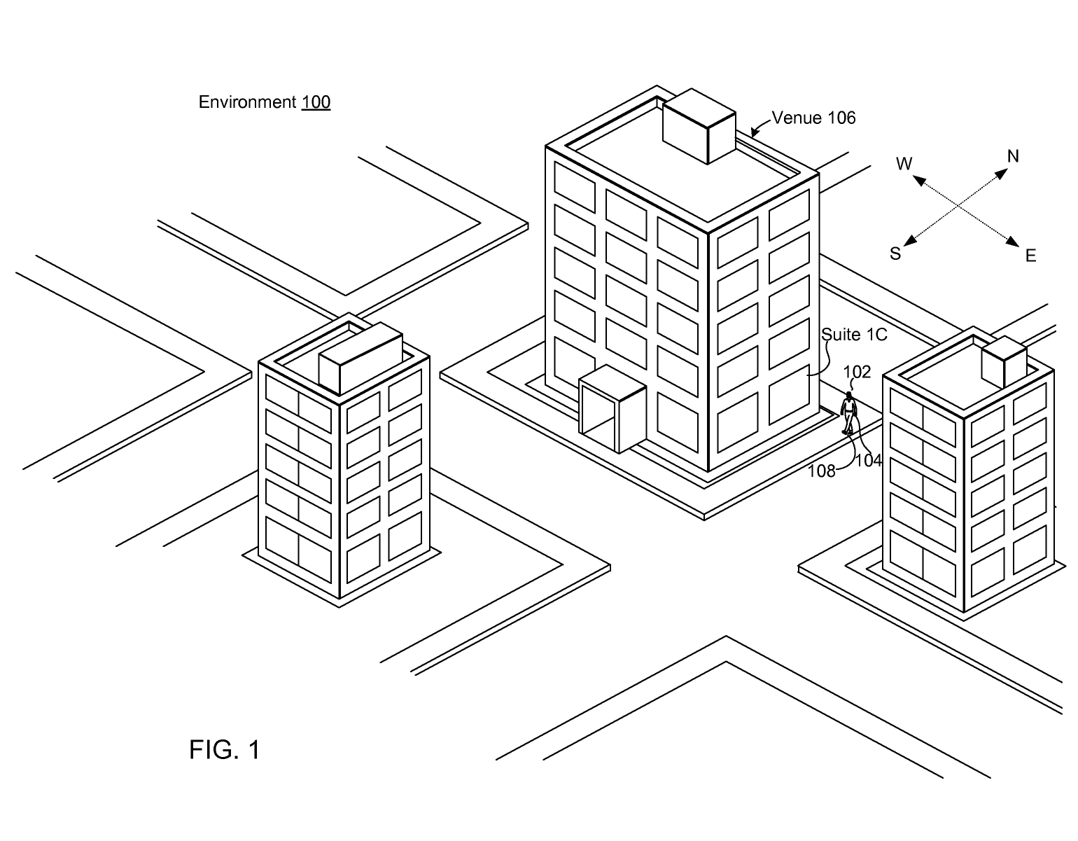

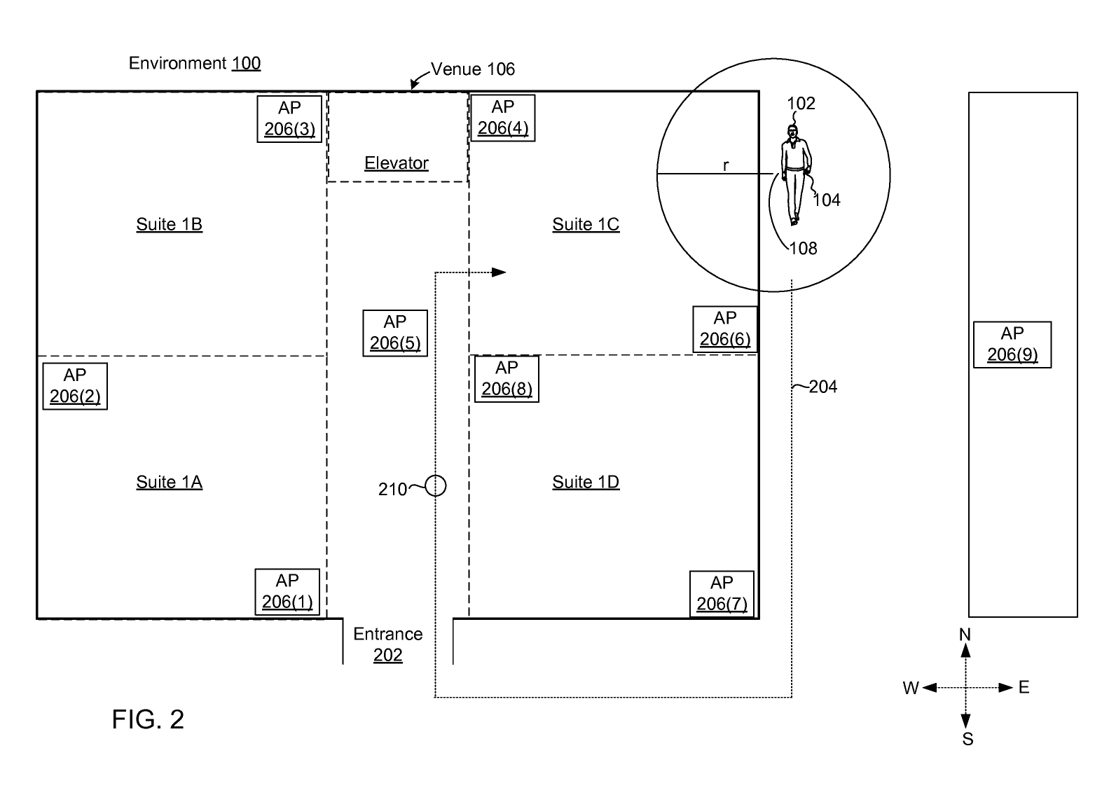

For purposes of explanation, consider introductory FIGS. 1-2 of an environment 100 in which the present concepts can be employed. FIG. 1 shows a perspective view of environment 100. FIG. 2 shows a ground level plan view of some of the elements shown in FIG. 1. In this example, assume for purposes of explanation that a user 102 is walking from North to South using his mobile device 104 to guide him to his desired destination. (Note that the mobile device is hard to visualize at the scale of the drawings.) In this case, the desired destination is Suite 10 in venue 106. In this example, the venue is an office building, but of course, the explanation can be applied to other venues.

In this case, the user 102 is walking from North to South along the sidewalk proximate to venue 106 and is right outside of the desired destination of Suite 10 at location 108. In fact, the user may be within the margin of error for available location techniques as represented by radius r in FIG. 2. As such, some techniques may misidentify the user as being in Suite 1C. Given that the user is approaching from the North, the user has not seen the entrance 202 that faces South. Thus, if the user is depending on guidance from the mobile device 104 to get to suite 10, the user may be very disappointed if the instructions incorrectly indicate that the user is at his desired destination. Instead, the present techniques can determine that the user is outside the venue. Based upon this information, the mobile device can provide directions indicated by dotted line 204 to guide the user into the venue via the entrance 202 and ultimately to Suite 1C.

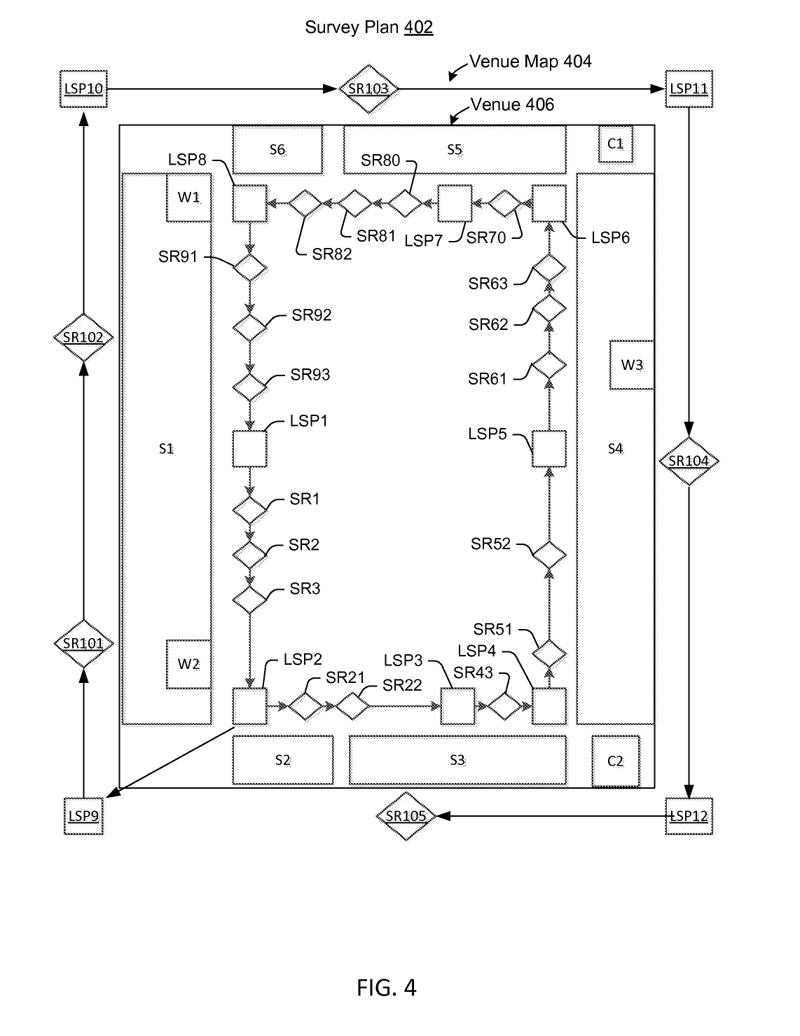

The present concepts can utilize various comparison techniques to determine whether the user is inside or outside the venue 106 at the instance illustrated in FIGS. 1-2. One such comparison technique can entail obtaining stored survey data relating to the venue 106. The stored survey data can include relative position data that includes internal data from inside the venue and external data from outside the venue. For instance, note that FIG. 2 shows eight wireless access points (AP) 206(1)-206(8) on the first floor of venue 106 and an additional wireless access point 206(9) in an adjacent building. Note further, that while not shown, venue 106 likely includes additional wireless access points on the upper floors. Thus, the density of wireless access points within the venue may be greater than the density outside of the venue. The stored survey data could indicate the number and location of wireless access points 206(1)-206(9) that were detected at specific locations within venue 106 and outside of venue 106. From one perspective, the survey data can be thought of as a surveyed fingerprint of the venue (or a portion of the venue). Assume for purposes of explanation, that the stored survey data indicates that wireless access points 206(1)-206(8) were detected from within the venue and are indicated as being within the venue, while the survey in the street between the two buildings (e.g. proximate to location 108) detected only wireless access points 206(6), 206(7) and 206(9). Among other factors, such a scenario can be caused by the high attenuation caused by the exterior walls of the venue 106 for signals passing from inside the venue to the outside. (An example survey technique is described in more detail below relative to FIG. 4).

The mobile device 104 can sense for relative location information, such as wireless access points as the user walks. Assume at location 108 that the mobile device senses wireless access points 206(6) and 206(9). From one perspective, this information can be thought of as the mobile device's sensed fingerprint. Since the mobile device senses wireless access points that the stored survey data indicate are in the venue 106 (e.g., wireless access point 206(6)), previous techniques may indicate that the user is in the venue. The present techniques can use the internal and external survey data as a filter to avoid such erroneous results. For instance, the survey data indicates wireless access points 206(1)-206(8) were sensed inside the venue while only wireless access points 206(6), 206(7), and 206(9) were sensed or detected outside of the venue.

Thus, some implementations can stipulate that the mobile device 104 has to detect more wireless access points 206 than can be detected outside (e.g., in this case three in the external survey data) for the mobile device to be deemed as being inside the venue. Stated another way, for the location of the mobile device to be deemed to be inside the venue, the mobile device has to detect more of the access points than can be detected from external to the venue as per the survey data. Therefore, in this example, the mobile device has to detect more than three wireless access points 206(1)-206(9) to be determined to be inside the venue. Sensing three or less than three can be treated as an indication that the mobile device is outside of the venue. Thus, even though the mobile device detects wireless access points 206(6) and 206(9) at location 108, this implementation can determine that location 108 is outside the venue 106.

Stated another way, detection of signals from within the venue 106 can be indicative that the mobile device 104 is proximate to the venue 106, but not conclusively indicative that the mobile device is in the venue. Thus, mappings or other instructions can be provided to the user to aid the user to get into the venue (for instance along path 204) to reach their desired destination of Suite 1C. For comparison sake, as the user follows path 204 to location 210 inside the venue, the mobile device might sense wireless access points 206(1), 206(2), 206(5), 206(7), and 206(8), for example. In that case, the mobile device detected five wireless access points that relate to the venue 106. Since five access points is greater than the three access points that the survey data detected outside the venue, the mobile device can be determined to be within the venue at location 210.

To summarize, the above discussion provides an example of how the present concepts can compare sensing data from a mobile device to survey data from inside and outside of a venue to determine whether the mobile device is inside or outside the venue. Viewed from one perspective, the mobile device can sense a fingerprint at a location proximate to a venue. The sensed fingerprint can be compared to survey fingerprints from inside and outside the venue to determine whether the location is inside or outside of the venue.

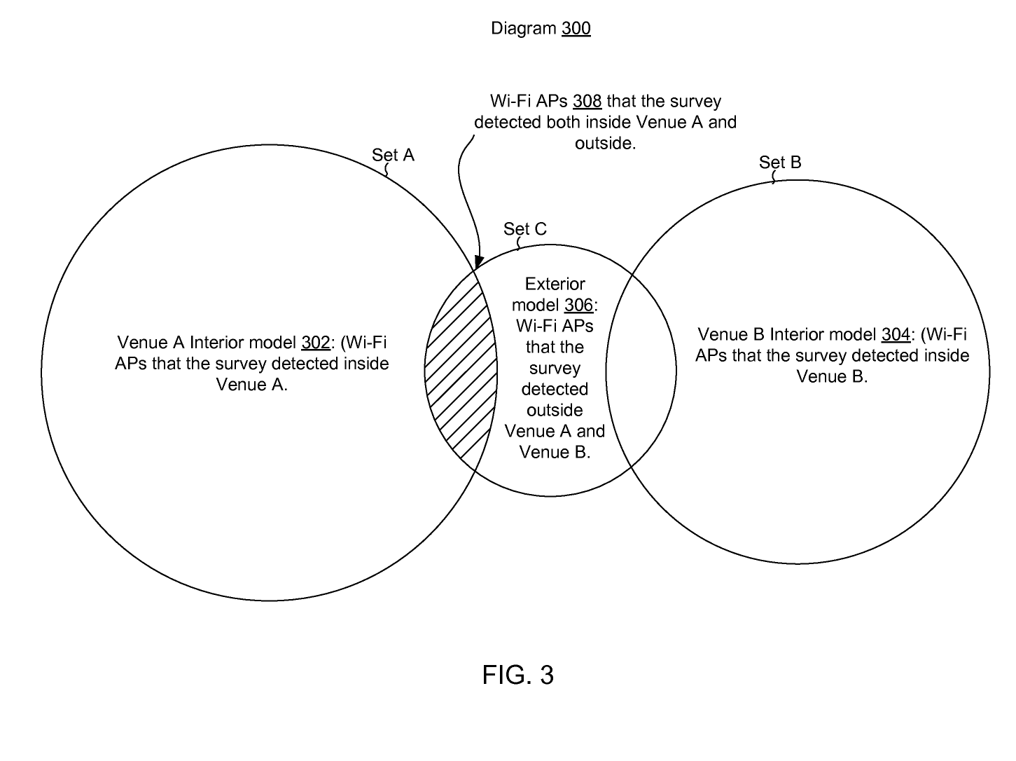

FIG. 3 shows a diagram 300 that illustrates how some of the present techniques can distinguish whether the user is inside or outside of a given venue. FIG. 3 relates to two venues: Venue A and Venue B and an exterior space C between the two venues. Set A can represent an interior model for Venue A as indicated at 302. The interior model of Venue A can include the access points (and/or other RF data) that the survey detected inside Venue A. Similarly, Set B can represent an interior model for Venue B as indicated at 304. The interior model of Venue B can include the access points (and/or other RF data) that the survey detected inside Venue B. Set C can represent an exterior model at 306. The exterior model can include access points (and/or other RF data) that the survey detected outside of Venue A and Venue B. Of particular interest to this discussion is the intersection of Set A and Set C indicated at 308. This intersection can represent access points that the survey data indicates as detectable both inside Venue A and outside of Venue A. Briefly, the exterior model can be used as a high-pass filter to validate a venue detection result at a subsequent instance, such as sensed by a mobile device. In some implementations of this filter, for a subsequent device to be considered to be inside Venue A, the number of access points detected by the mobile device must exceed the number of access points related to Venue A detected in the exterior model. If the venue detection result fails the validation, the mobile device is most likely just outside the venue.

More specifically, in one implementation as explained relative to diagram 300, let Set A be the set of access points that can be detected inside Venue A. Let Set C be the set of access points that can be detected outside Venue A (around the exterior areas around Venue A). Let A∩C be the set of access points that can be detected both inside and outside of Venue A. Let f be an access point fingerprint that consists of the ID's of access points detected.

Then the access point fingerprint f is the union of three subsets: (1) fA consists of access points that are in Set A; (2) fC consists of access points that are in Set C; (3) fA∩C consists of access points that are in both Set A and C. It can be seen from the Set relationships that if a sensed fingerprint f (e.g., detected by a mobile device) is from inside Venue A, then the size of fA will be greater than the size of fA∩C; otherwise, fingerprint f is most likely from outside Venue A. In other words, some implementations can use the size of fA∩C as the threshold for determining whether a sensed fingerprint f is inside or outside of Venue A.

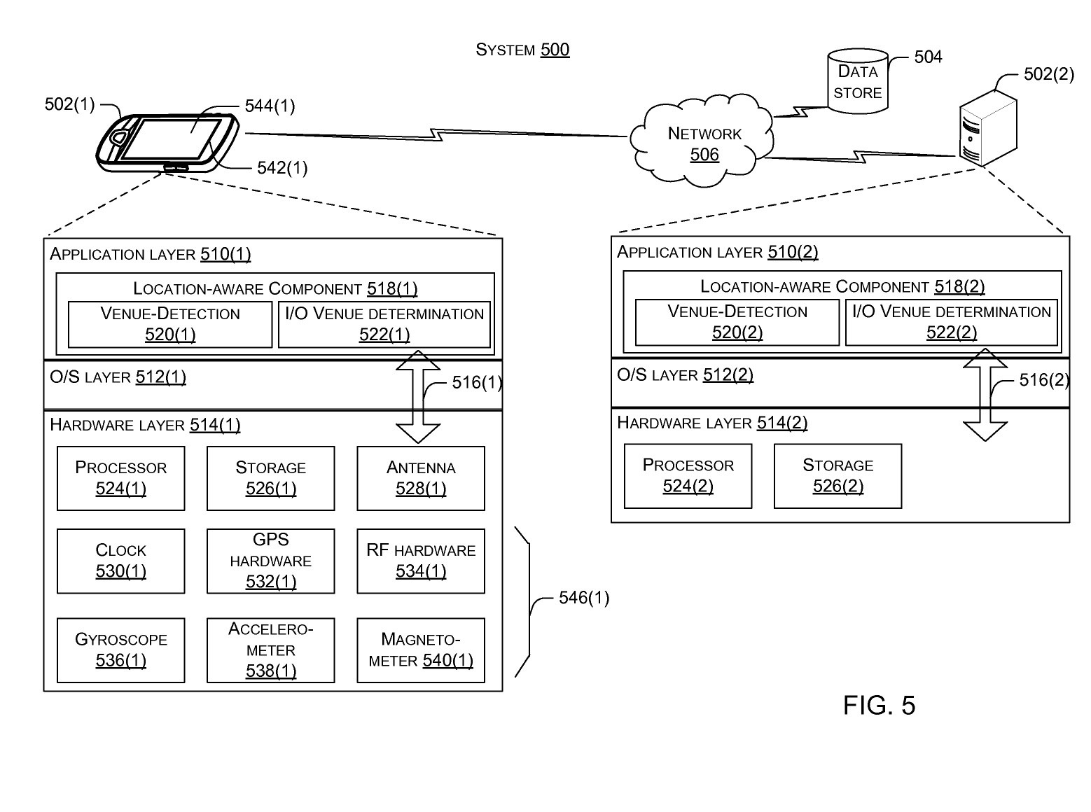

In the discussion that follows, FIG. 4 describes an example survey technique that can provide venue survey data described above and FIG. 5 describes an example system that can include a mobile device similar to the mobile device introduced relative to FIG. 1.

FIG. 4 illustrates an example survey plan 402 associated with a venue map 404 of a venue 406. In this example, the venue 406 is a shopping mall that includes several stores. Of course, other venues can be mapped utilizing similar techniques. This venue map 404 can include representations of several stores (e.g., S1, S2, S3, S4, S5, and S6). Sensor data can be obtained at survey points relative to the stores and/or relative to the venue that includes the stores. The discussion below describes logical survey points, but other types of survey points can be utilized alternatively or additionally to logical survey points. In the illustrated configuration, the survey plan may identify several logical survey points (LSP) (e.g., LSP1, LSP2, LSP3, LSP4, LSP5, LSP6, LSP7, LSP8, LSP9, LSP10, LSP11, and/or LSP12). Note that while all of the logical survey points are proximate to the venue in this example, logical survey points LSP1-LSP8 are inside the venue and logical survey points LSP9-LSP12 are outside the venue.

A surveyor may be provided with instructions that facilitate moving from LSP to LSP in order. As the surveyor travels a path from LSP to LSP, sensor readings may be acquired. For example, a sensor reading (SR) may be acquired at points SR1, SR2, SR3 . . . SR21, SR22, . . . SR 43, . . . SR51, SR52, . . . SR61, SR62, SR63, . . . SR70, . . . SR80, SR81, SR82, . . . SR91, SR92, SR93, . . . SR101, SR102, SR103, SR104, and SR105). This technique can be repeated on additional floors if present. While the LSPs are pre-defined, the precise locations of the SRs may not be pre-planned. The SRs are the places where sensor readings are taken. Sensor readings may be acquired at some sampling rate. As a surveyor passes a logical survey point, an optional action (e.g., tap, button press, shake) may be undertaken to register the surveyor to the LSP. The sensor readings may be taken continuously, after a certain step count has been detected, after a certain time interval has passed, and/or at other times. Further, the sensor readings may be recorded consistently throughout the process or under different conditions. For instance, the frequency of sensor readings may be the same both inside and outside, or the frequency may be different inside than outside, among other configurations.

The sensor readings can relate to external signals (e.g., from outside the sensing device) and/or internal signals (e.g., from inside the sensing device). For instance, external signals can include Wi-Fi signals and/or cellular signals, among others. Internal signals can include signals from compasses, magnetometers, accelerometers, gyroscopes, barometers, etc. on the device. In the illustrated example, the sensor readings may be retrieved from, for example, Wi-Fi access points W1, W2, W3 or from cellular devices C1 and C2, among others. A ground truth (e.g., precise latitude/longitude) may or may not be available for a logical survey point. When a ground truth is available, the venue map 404 can be bound to the survey plan 402 using the ground truth associated with the logical survey point.

These surveying techniques can contribute to accurately locating individual users (e.g., their mobile devices) and to providing maps and/or directions, if desired. Often, users like having maps so that they know where they are, so that they know where they've been, so they'll know how to get from where they are to where they want to be, and/or for other reasons. For example, when in a mall, a shopper may like to know how to get from one store to another store. Similarly, in a large office building, a mail room person may like to know how to get to a particular worker's desk to be able to deliver the mail. Likewise, in a warren of underground sewer pipes, a worker may want to know how to get to a particular clean out valve. Unfortunately, maps about locations can change. For example, there may be two, three, or a dozen revisions of a map for a venue.

Additionally, the physical configuration of a mall, of an office building, or of a network of underground pipes can change. More generally, the physical reality of a physical geography can change or the mapping of a location can change. These changes may happen so rapidly that maps quickly become obsolete or inaccurate. For example, the aisles and booths in a convention center can be changed from event to event. Similarly, the locations of various stores and kiosks in a mall can change. Likewise, the location, size, number, and/or orientation of cubicles in an office can change. Thus, maps can and do get out-of-date. There are additional sources of change. Even if the physical reality of a location remains the same, a map of that location may change due to factors including, but not limited to, corrections and scaling.

Conventional indoor maps for mobile devices have relied on mappings between sensor readings and physical locations (e.g., map locations) on corresponding indoor maps. However, maps for a venue may change from time to time, creating multiple versions of maps for a venue. Additionally, if the physical reality changes, the mapping between sensor readings and physical locations may become out-of-date or obsolete. Even if a user has an accurate GPS fix or an accurate non-GPS fix, that fix is substantially worthless without a binding to an up-to-date map.

Example techniques can anticipate multiple versions of maps, changing maps, and changing physical realities and are configured to facilitate selectively re-binding sensor data acquired for one version of a venue map for use with another version of a venue map. The re-binding is possible, at least in part, because of how the sensor data is acquired in the first place. Example techniques can acquire sensor readings that are relative to logical survey points that may be related to different venue maps rather than being relative to physical co-ordinates on a single fixed map. The sensor readings are bound indirectly to physical locations through an intermediary logical location (e.g., survey point) rather than being bound directly to physical locations. While a binding between a physical location (e.g., map location) and a logical location is made for a particular map of a physical reality as reflected in a particular version of a venue map, the binding can be manipulated over time to accommodate changing physical realities so that the binding will be consistent with the most recent map version. The particular mapping of a physical reality may be represented by one version or instance of a venue map. Thus, an accurate fix may be related to a current map through the relationship between a logical survey point and the current map.

A survey point can be immutable, both logically and in physical reality. Example techniques are configured to handle changes in the mapping of the logical to the pseudo physical reality in different map versions. Consider a survey point described as being a turn around the coffee shop in the mall. A first version of a map (e.g., map1)) may map the survey point to {venue name, floor, latitude1, longitude1}. This is pseudo reality version 1. A second version of a map (e.g., map2) may map the survey point to {venue name, floor, latitude2, longitude2). This is pseudo reality version 2. The precise position of the survey point has not been mentioned. Even though the physical realities behind both map versions are the same, the mapping is subject to map accuracy, scaling, and other differences that may exist between the two versions of the map. If the coffee shop actually changed their location so that the survey point became inaccessible, then a new survey point could be created to represent a new turn location.

Example techniques can associate survey plans with the venue map. In one implementation, the survey plan may be part of the metadata for a venue map. The survey plan becomes the basis for indoor and/or outdoor data collection by a surveyor. A survey plan includes at least one survey path. A survey path can be defined by a starting survey point and an ending survey point. In some cases, a survey path can consist of one or more connected segments. A segment can be defined by a starting survey point and an ending survey point. A survey path may also be described by a starting point and a direction of travel. A survey path may also be described in a way that makes it likely that the surveyor will travel along a logical survey path without having to necessarily start at a logical survey point. A survey point is a recognizable location that can be used as a landmark.

Logical survey points may be human recognizable, recognizable by an apparatus, recognizable by a process, and/or recognizable in other ways that do not depend on co-ordinates. For example, a survey point may be described as being near the front door of a certain store while facing the front door of a second store. A logical survey point can have a unique identifier that does not depend on a position described by a co-ordinate system. A logical survey point can include information that describes a recognizable location in the venue associated with the venue map. A logical survey point can store coordinate information sufficient for registering the recognizable location with a position on the venue map.

As a surveyor moves from logical survey point to logical survey point, the surveyor can collect sensor information at a number of sensor reading points. The logical survey points can be pre-defined; the sensor reading points are not. The sensor reading points are places where a sensor records sensor information. Sensor readings may be taken on each step of the surveyor, at regular time intervals, and under other controls. In some implementations, the surveyor can start the sensor reading recording at the beginning of the survey. When the recording starts, sensor readings will be recorded continuously at a certain frequency, say 50 Hz. The sensor readings recording does not have to be triggered by the action of the surveyor during the survey process except for perhaps the manual start and stop of the recording on the mobile device. The sensor information provides a signature or fingerprint for a location. Conventional systems bind the fingerprints to physical locations on a map using a co-ordinate system. Example techniques can take a more flexible indirect approach of relating the fingerprint to a logical location. An underlying co-ordinate for a fingerprint location may later be generated using a co-ordinate established for the logical location. The logical location may be bound to different maps and thus the fingerprint may also be used in different maps.

In one implementation, a logical survey point may be established at a human recognizable location like a corner or turn that can be used as a landmark during a walking survey of an indoor venue. Conventional systems may also have used survey points. However the conventional survey points were identified by their physical attributes (e.g., latitude/longitude) rather than by their logical attributes (e.g., center of the first aisle, front of a store). Unfortunately, different versions of maps for a location can change or be different. For example, an aisle in a convention center may be rendered in one location on a first version of a map but may be rendered in a second location on a second version of the map. Additionally, the physical co-ordinates of a logical survey point can change from one version of a venue map to another version of a venue map as the physical reality changes. For example, the first aisle in a convention center may be ten feet from the north wall of a convention center for a first event but may be twenty five feet from the north wall of the convention center for a second event. However, for both events, a survey plan could direct a surveyor to start “in the center of the first aisle.” The “center of the first aisle” could be bound to different actual physical co-ordinates for the two versions of the venue map.

Example techniques can rely on logical survey points instead of fixed physical survey points. A logical survey point may be identified using something other than a co-ordinate system. For example, a logical survey point may have a name and a unique identifier (e.g., globally unique identifier (GUID)). The unique identifier may be a persistent identifier. For a particular instance of a venue, a logical survey point may be associated with certain physical co-ordinates. However the physical co-ordinates can be provisional. As the map changes from version to version, or as the geography of a venue changes (e.g., wall relocated, walkway relocated, fountain added, fountain removed), the physical co-ordinates of a logical co-ordinate may change. The persistent identifier for the logical survey point may not change from version to version of the venue map. Note that if the physical layout changes, some new survey points may be required as old survey points may become unreachable.

A rigorous survey plan for decoupled sensor data collection can rely on moving from logical survey point to logical survey point and acquiring fingerprints at positions between the logical survey points. Rather than telling a surveyor to start at a specific latitude/longitude co-ordinate, example systems and methods can tell a surveyor to start at the co-ordinates associated with a logical location (e.g., front of store). In some configurations, the surveyor only needs to know/identify the logical locations throughout the survey process and no physical coordinates (latitude/longitude) are involved in the survey process. The binding of the physical location to the logical location can happen later when the sensor data from survey is processed. This can decouple the initial positioning from any particular instance of a map. Although decoupled, the physical co-ordinates of the logical location can be bound to a particular instance of the venue map. Given a map version, a survey point in a given survey plan may be assigned physical co-ordinates for that map version.

The venue map may be described by a venue map data set. The venue map data set may store information including, but not limited to, a name of the venue, a name of the venue map, information about multiple floors of the venue (if present), an identifier of the venue, an identifier of the venue map, a location of the venue, a space represented by the venue map, an element in the space, and/or a symbolic depiction of relationships between elements in the space. In one implementation, the survey plan may be embedded in metadata associated with the venue map.

The survey plan may be described by a survey plan data set. The survey plan data set may store information including, but not limited to, a name of the survey plan, an identifier of the survey plan, and a venue map to which the survey plan applies.

The survey plan can include information about a survey path. In one implementation, a survey path may be defined by a starting logical survey point and an ending logical survey point. In another implementation, a survey path may be defined by a starting logical survey point and a direction to travel. In another implementation, a survey path may be defined using directions that make it likely that a logical survey point will be traversed without requiring either starting or stopping at a logical survey point. In still another implementation, a survey path can include one or more segments. Each segment can be defined by a starting and an ending logical survey point or other types of definitions. Other definitions of survey paths may be employed. In one implementation, a logical survey point includes a unique co-ordinate free identifier, a description of a recognizable location in the venue, and a co-ordinate configured to register the logical survey point to the venue map. The co-ordinate free identifier may be, for example, a persistent globally unique identifier (GUID). Other identifiers may be employed. The description of the recognizable location may take different forms. In different examples the description of the recognizable location may include a textual description of the recognizable location, a visual description of the recognizable location, or a sensor-based description of the recognizable location. By way of illustration, a logical survey point may include a description that reads “position yourself just to the right of the front door of Store1 while facing the clown in front of Restaurant1.”

Note that FIG. 4 and the description above that relates to FIG. 4 describes in detail specific types of venue maps and how to generate venue maps. The present implementations can alternatively or additionally utilize other types of venue maps. For instance, venue maps can be created via crowdsourcing or other techniques and/or through a combination of techniques. For instance, survey data for a venue could be gathered as explained above relative to FIG. 4 and then updated via crowdsourcing or other technique.

### System Example

FIG. 5 shows an example system 500 that includes multiple devices 502. In this case, device 502(1) is a mobile device that is similar to mobile device 104 of FIG. 1 and device 502(2) is a server type computing device that is remote from the mobile device. System 500 also includes a data store 504 and one or more networks 506 over which the devices 502 can communicate with one another and/or the data store. The venue map 404 described above relative to FIG. 4 (and venue maps for other venues) can be stored on data store 504. For the sake of brevity, elements of the two devices 502(1) and 502(2) are discussed generically where feasible. When an individual device is discussed, the appropriate suffix “(1)” or “(2)” is utilized, otherwise the discussion can be generic to the devices.

Generally, devices 502 can include an application layer 510, an operating system (O/S) layer 512, and a hardware layer 514. Drivers 516 can facilitate interaction between the hardware layer and the operating system layer and the application layer.

In this configuration, the application layer 510 can include a location-aware component 518. The location-aware component can include a venue detection module 520 and an inside outside (I/O) determination module 522.

The hardware layer 514 can include a processor 524 and storage 526. Relative to device 502(1), the hardware layer 514(1) can further include an antenna 528(1), a clock 530(1), GPS hardware 532(1), radio frequency (RF) hardware 534(1), a gyroscope 536(1), an accelerometer 538(1), a magnetometer 540(1), and a display 542(1), among others. Location related graphical user interfaces (GUIs) 544(1) can be presented on the display 542(1). For instance, the GUI can include a visualization of a map from a present location to a desired location in a venue and/or associated directions.

GPS hardware 532(1), radio frequency (RF) hardware 534(1), gyroscope 536(1), accelerometer 538(1), and magnetometer 540(1) can be thought of as examples of sensors 546(1) that can provide location related information. GPS hardware 532(1) can function to provide absolute location information for the device. The RF hardware 534(1) can include hardware configured to sense and/or transmit radio frequency signals. The RF hardware can include cellular hardware for sending and receiving cellular signals and/or Wi-Fi hardware for sending and receiving Wi-Fi signals, and/or Bluetooth hardware, among others. The RF hardware 534(1), gyroscope 536(1), accelerometer 538(1), and magnetometer 540(1) can provide relative location information about the location of the device.

In some configurations, remote device 502(2) can actively provide a location service to device 502(1). For instance, the remote device 502(2) can request location related data sensed by device 502(1). For example, this can be absolute position information from the GPS hardware 532(1) and/or relative position information from the RF hardware 534(1), gyroscope 536(1), accelerometer 538(1), and/or magnetometer 540(1). In one such example, the location-aware component 518(1) can work in cooperation with location-aware component 518(2) to send location related information to the remote device. For instance, the location-aware component 518(1) can send GPS information to the location-aware component 518(2). The location-aware component 518(2) can access data store 504 to determine if any venues are proximate to device 502(1)'s reported location. If so, location-aware component 518(2) can download venue maps for the proximate venues for caching on the storage 526(1) of device 502(1) (e.g., a local data store cache of local venues). Lacking GPS information (or in addition to the GPS information), device 502(1) may detect RF signals that include identifying information. For instance, RF hardware 534(1) may detect one or more access point signal(s) and/or one or more cell tower signal(s). Each of these signals can include a unique identifier. The location-aware component 518(2) can check the data store 504 for the unique identifier. The data store can reference the unique identifier to a specific venue or localized area (such as a trilateralized area). The location-aware component 518(2) can retrieve information (such as venue maps) about the venue or venues from the data store. Thus, in this configuration, some of the location-aware functionality can be provided by the remote device 502(2) and some of the functionality can be performed locally by device 502(1).

The venue detection module 520(2) can be configured to analyze the information sensed by device 502(1) and the venue information from the data store 504 to determine whether the device 502(1) is proximate to an individual venue. In an instance where the venue detection module determines that the device 502(1) is proximate to an individual venue (or a few venues), the inside outside venue determination module 522(2) can be configured to further analyze the information to determine if the device is inside an individual venue. Examples of this analysis are described above relative to FIGS. 2-3. The location-aware component 518(1) can alternatively or additionally utilize the location information to guide the user to a desired location (e.g., show a path on a graphical user interface (GUI) and/or walk four steps forward and then turn left). In such a case, the location-aware component can utilize information from the gyroscope 536(1), accelerometer 538(1), and magnetometer 540(1) as the user follows the instructions.

Note that the above example is just one of many contemplated system configurations. In other configurations, location-aware component 518(1) can be more robust. For instance, the location-aware component 518(1) can communicate directly with the data store 504 and download information about local venues for caching on device 502(1). In such a configuration, all of the processing can be performed locally on device 502(1) by location-aware component 518(1). In another configuration, more or all of the processing can be performed by remote device 502(2) with the results presented on device 502(1). Also, in the illustrated configuration the data store 504 is independent from the remote device 502(2). In other configurations, the remote device 502(2) may maintain the data store 504.

As mentioned above, devices 502 can be thought of as computers or computing devices as defined to be any type of device that has some amount of processing capability and/or storage capability. Processing capability can be provided by one or more processors that can execute data in the form of computer-readable instructions to provide a functionality. Data, such as computer-readable instructions and/or user-related data, can be stored on storage/memory. The storage/memory can be internal and/or external to the computer. The storage/memory can include any one or more of volatile or non-volatile memory, hard drives, flash storage devices, and/or optical storage devices (e.g., CDs, DVDs etc.), among others. As used herein, the term “computer-readable media” can include signals. In contrast, the term “computer-readable storage media” excludes signals. Computer-readable storage media can include “computer-readable storage devices”. Examples of computer-readable storage devices include volatile storage media, such as RAM, and non-volatile storage media, such as hard drives, optical discs, and flash memory, among others.

Examples of devices 502 can include traditional computing devices, such as servers, personal computers, desktop computers, notebook computers, cell phones, smart phones, personal digital assistants, pad type computers, mobile devices, wearable smart devices, wireless devices, cameras, routers, or any of a myriad of ever-evolving or yet to be developed types of computing devices. A mobile computer or mobile device can be any type of computing device that is readily transported by a user and may have a self-contained power source (e.g., battery). Similarly, a wireless device can be any type of computing device that has some capability to communicate with other devices without being physically connected to them. In some cases, a wireless device may have both wireless and wired capabilities. For instance, a router can be physically connected (e.g., wired) to a network, such as with an Ethernet cable, and wirelessly communicate with devices over radio channels, such as radio white space channels and/or Wi-Fi channels, among others.

In the illustrated implementation, devices 502 are configured with general purpose processors and storage/memory. In some configurations, such devices can include a system on a chip (SOC) type design. In such a case, functionalities can be integrated on a single SOC or multiple coupled SOCs. In one such example, the computing device can include shared resources and dedicated resources. An interface(s) can facilitate communication between the shared resources and the dedicated resources. As the name implies, dedicated resources can be thought of as including individual portions that are dedicated to achieving specific functionalities. For instance, in this example, the dedicated resources can include any of GPS hardware 532(1), RF hardware 534(1), gyroscope 536(1), accelerometer 538(1), and/or magnetometer 540(1).

Shared resources can be storage, processing units, etc. that can be used by multiple functionalities. In this example, the shared resources can include the processor and/or storage/memory. In one case, the location-aware component 518 can be implemented as dedicated resources. In other configurations, this component can be implemented on the shared resources and/or the processor can be implemented on the dedicated resources.

In some configurations, the location-aware component 518 can be installed during manufacture of the device 502 or by an intermediary that prepares the device for sale to the end user. In other instances, the end user may install the location-aware component, such as in the form of a downloadable application or from a USB thumb drive, among others.

Note that some implementations can utilize information about a device, such as location information. Any such information gathering can be conducted in a manner that protects the security and privacy of the user. The user can be given notice of the use and allowed to opt-in, opt-out, and/or define such use. In any event, the present implementations can be accomplished in a manner that utilizes the information in a very targeted manner that limits the use of the information to accomplishing the present location based concepts.

### Method Examples

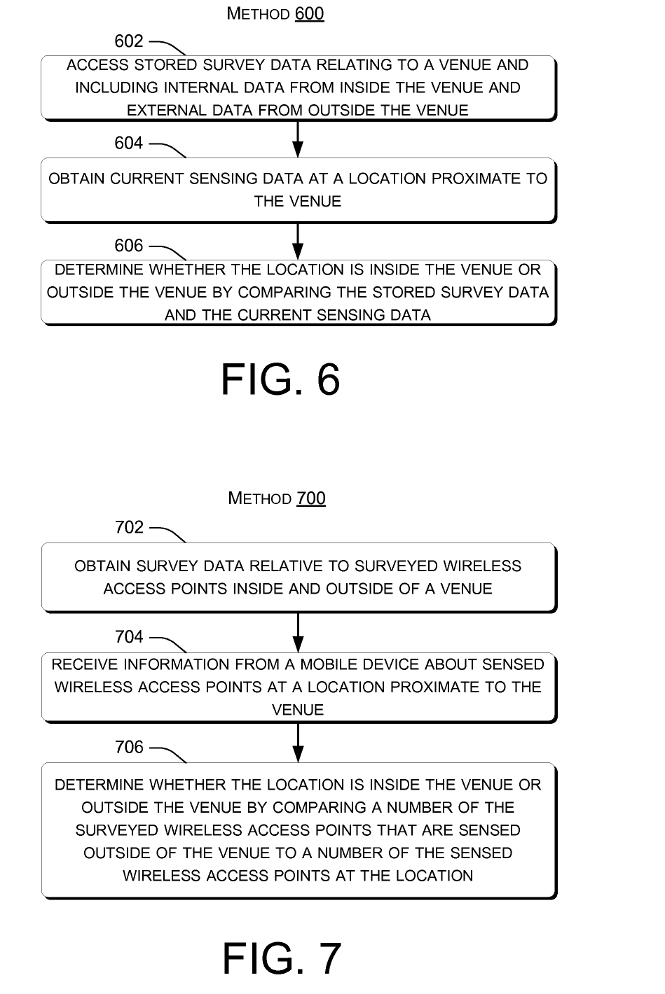

FIG. 6 illustrates a flowchart of a method or technique 600 that is consistent with at least some implementations of the present concepts.

At block 602, the method can access stored survey data relating to a venue. The venue data can include internal data from inside the venue and external data from outside the venue.

At block 604, the method can obtain current sensing data at a location proximate to the venue.

At block 606, the method can determine whether the location is inside the venue or outside the venue by comparing the stored survey data and the current sensing data.

FIG. 7 illustrates a flowchart of a method or technique 700 that is consistent with at least some implementations of the present concepts.

At block 702, the method can obtain survey data relative to surveyed wireless access points inside and outside of a venue.

At block 704, the method can receive information from a mobile device about sensed wireless access points at a location proximate to the venue.

At block 706, the method can determine whether the location is inside the venue or outside the venue. The determination can be accomplished by comparing a number of the surveyed wireless access points that are sensed outside of the venue to a number of the sensed wireless access points at the location.

The order in which the above methods are described is not intended to be construed as a limitation, and any number of the described blocks can be combined in any order to implement the method, or an alternate method. Furthermore, the method can be implemented in any suitable hardware, software, firmware, or combination thereof, such that a computing device can implement the method (e.g., computer-implemented method). In one case, the method is stored on a computer-readable storage media as a set of instructions such that execution by a processor of a computing device causes the computing device to perform the method.

### CONCLUSION

Although techniques, methods, devices, systems, etc., pertaining to location-aware implementations are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. One or more computer-readable storage media having instructions stored thereon that when executed by a processor of a computing device cause the computing device to perform acts, comprising:
accessing stored survey data relating to a venue and including internal data from inside the venue and external data from outside the venue;
obtaining current sensing data at a location proximate to the venue; and,
determining whether the location is inside the venue or outside the venue by comparing the stored survey data and the current sensing data.

2. The one or more computer-readable storage media of claim 1, wherein the stored survey data includes external data sensed from wireless access points, Bluetooth enabled devices, or cellular towers that are external to a device that gathered the stored survey data and internal data sensed from accelerometers, gyroscopes, and compasses within the device.

3. The one or more computer-readable storage media of claim 1, wherein the determining comprises identifying a first set of access points surveyed inside the venue and a second set of access points surveyed outside the venue and identifying a third set that is common to both the first set and the second set, and in an instance where the current sensing data detects more access points than is contained in the third set, determining that the location is inside the venue, and in an instance where the current sensing data detects fewer access points than is contained in the third set, determining that the location is outside the venue.

4. The one or more computer-readable storage media of claim 1, wherein the determining comprises comparing a set of access points surveyed outside the venue to the current sensing, and in an instance where the current sensing data detects more access points than is contained in the set, determining that the location is inside the venue.

5. The one or more computer-readable storage media of claim 1, wherein the accessing, obtaining, and determining are performed by a server based location service.

6. The one or more computer-readable storage media of claim 5, wherein the accessing comprises accessing from a data store maintained by the server based location service.

7. The one or more computer-readable storage media of claim 1, wherein the obtaining comprises obtaining from a mobile device at the location.

8. The one or more computer-readable storage media of claim 1, wherein the accessing, obtaining, and determining are performed by a mobile device.

9. The one or more computer-readable storage media of claim 8, wherein the accessing comprises retrieving the stored survey data and caching the stored survey data on the mobile device.

10. The one or more computer-readable storage media of claim 8, wherein the obtaining comprises sensing radio frequencies at the location.

11. A computer-implemented method, comprising:
obtaining survey data relative to surveyed wireless access points inside and outside of a venue;
receiving information from a mobile device about sensed wireless access points at a location proximate to the venue; and,
determining whether the location is inside the venue or outside the venue by comparing a number of the surveyed wireless access points that are sensed outside of the venue in the survey data to a number of the sensed wireless access points at the location.

12. The computer-implemented method of claim 11, wherein the survey data comprises a venue map of the venue.

13. The computer-implemented method of claim 11, wherein the comparing comprises identifying a set of individual surveyed wireless access points that are surveyed both inside and outside the venue.

14. The computer-implemented method of claim 13, wherein in an instance where a number of the sensed wireless access points is greater than a number in the set, determining that the location is inside of the venue.

15. The computer-implemented method of claim 11, further comprising sending results of the determining to the mobile device.

16. A mobile device, comprising:
a sensor configured to sense radio frequency signals;
storage and a processor, the storage having instructions stored thereon that when executed by the processor accomplish:
storing venue information on the storage; the venue information relating to surveyed sensing conducted inside and outside the venue,
causing the sensor to sense radio frequency signals at a location proximate to the venue, and,
comparing the stored venue information to the sensed radio frequency signals to determine whether the location is inside or outside of the venue.

17. The mobile device of claim 16, further comprising a display and where the instructions further cause the processor to accomplish presenting a graphical user interface (GUI) that shows the location relative to the venue.

18. The mobile device of claim 17, wherein the GUI further allows a user to enter a desired location in the venue and wherein the presenting also includes a visualization and instructions that guide the user from the location to the desired location.

19. The mobile device of claim 16, further comprising an antenna and wherein the instructions further cause the processor to send the sensed radio frequency signals to a remote data store via the antenna and request the venue information based upon the sensed radio frequency signals.

20. The mobile device of claim 16, wherein the sensor comprises radio frequency hardware.
